(19) United States
(12) Patent Application Publication
(10) Pub. No.: US 2007/0103902 A1
(43) Pub. Date: May 10, 2007

(54) Lighting fixture

(76) Inventor: Yu-Hsiang Hsiao, Qidu District (TW)

Correspondence Address: PRO-TECHTOR INTERNATIONAL SERVICES, 20775 NORADA CT., SARATOGA, CA, 95070, US

(21) Appl. No.: 11/270,027

(22) Filed: Nov. 8, 2005

(51) Int. Cl. F21V 11/00

(52) U.S. Cl. 362/240

(57) ABSTRACT

A lighting fixture made in the form of a wall (floor) tile or a light box is disclosed to include a holder base holding a substrate, a plurality of light emitting devices, for example, LEDs or luminescent lamps installed in the substrate and electrically connected to together, and a cover shell, which is directly molded on the holder base and the substrate and the light emitting devices and has a patterned light-permeable area for the passing of the light from the light emitting devices.

### BACKGROUND OF THE INVENTION

1. Field of the Invention

The present invention relates to lamps and more particularly, to a lighting fixture that can be used as a wall tile, floor tile, or lighting signboard.

2. Description of the Related Art:

When a building is established, small lighting fixtures may be installed in the outside wall or the floor of the building and turned on in the light to decorate the building.

Conventional small lighting fixtures for this purpose consume much electricity during operation. Further, these conventional small lighting fixtures are not durable in sue because they are not waterproof, weatherproof, or compression resistant.

For the advantages of low power consumption or long service life, light emitting diodes have been intensively used in small lighting fixtures. When wishing to show a particular pattern or design with small lighting fixtures, a big number of small lighting fixtures shall be used. It is complicated to install a big number of small lighting fixtures in order to show a particular pattern or design.

### SUMMARY OF THE INVENTION

The present invention has been accomplished under the circumstances in view. It is the main object of the present invention to provide a lighting fixture that can be used as a well tile, floor tile, or lighting signboard. It is another object of the present invention to provide a lighting fixture, which shows a particular design.

The lighting fixture comprises a holder base, a substrate fixedly mounted on the holder base, a plurality of light emitting devices installed in the substrate and electrically connected to together, and a cover shell package covering the holder base and the substrate and the light emitting devices.

### BRIEF DESCRIPTION OF THE DRAWINGS

FIG. 1 is a schematic top of a lighting fixture according to a first embodiment of the present invention.

FIGS. 2A˜2C show the manufacturing flow chart of the lighting fixture according to the first embodiment of the present invention.

FIG. 3 is a schematic top view of a lighting fixture according to a second embodiment of the present invention.

FIG. 4 is sectional view of a lighting fixture according to a third embodiment of the present invention.

FIG. 5 is a sectional view of a lighting fixture according to a fourth embodiment of the present invention.

FIG. 6 is a sectional view of a lighting fixture according to a fifth embodiment of the present invention.

FIG. 7 is a sectional view of a lighting fixture according to a fifth embodiment of the present invention.

FIG. 8 is a sectional view of a lighting fixture according to a seventh embodiment of the present invention.

### DETAILED DESCRIPTION OF THE PREFERRED EMBODIMENT

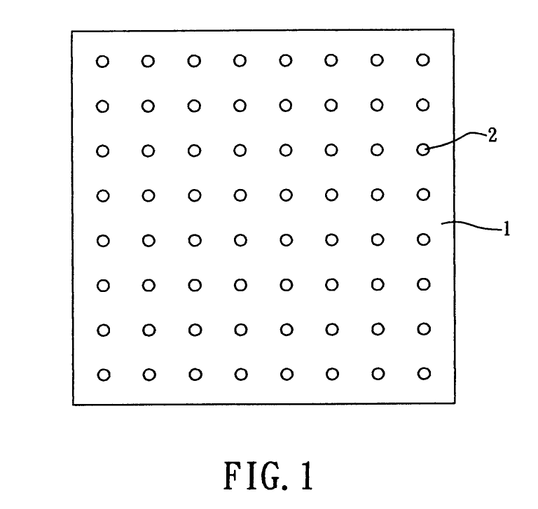

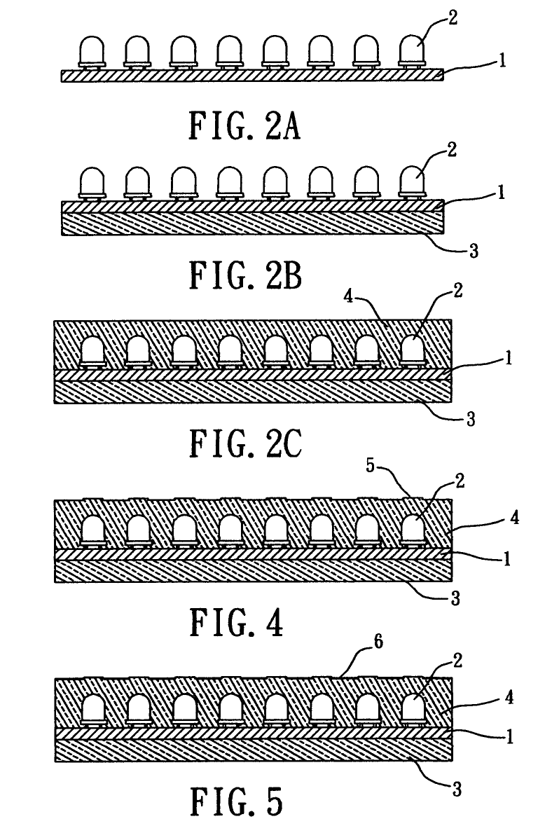

Referring to FIGS. 1, 2A, 2B and 2C, a lighting fixture in accordance with the present invention is shown comprising a substrate 1, a plurality of light emitting devices 2, a holder base 3, and a cover shell 4. The lighting structure can be made in the form of a brick, wall tile, or signboard.

The substrate 1 can be a printed circuit board, or a polycarbonate or acrylic board, having an electric circuit thereon and an electric wire for connection to an external device to receive power supply and/or control signal from the external device.

The light emitting devices 2 are installed in the substrate 1 and arranged in an array subject to a predetermined pattern. The light emitting devices 2 can LEDs (light emitting diodes) or luminescent lamps of same or different colors.

After installation of the light emitting devices 2 in the substrate 1, the substrate 1 is mounted in the holder base 3. The holder base 3 is molded from a resin mixture containing a hard grained material such as sands, glass grains, or metal grains, ceramic grains, for the advantage of waterproof, compression resisting and heat resisting characteristics. Alternatively, the holder base 3 can be molded from a resin mixture containing a fire retardant.

After the substrate 1, the light emitting devices 2 and the holder base 3 have been fastened together, this semi-finished product is put in a mold is molded with a resin to form the designed cover shell 4 that admits light. The cover shell 4 can be colored with multiple color pigments. In this case, the light emitting devices 2 are preferably selected from white light LEDs.

After connection of the electric wire of the substrate 1 of the finished lighting fixture is electrically connected to power source. When electrically connected, the light emitting devices 2 emit light through the cover shell 4, which guides the light of the light emitting devices 2 toward the outside.

According to the embodiment shown in FIG. 1, the light emitting devices 2 are transversely and longitudinally aligned on the substrate 1, and the lighting fixture is made in the form of a wall (floor) tile that can be installed in the wall or floor for decoration.

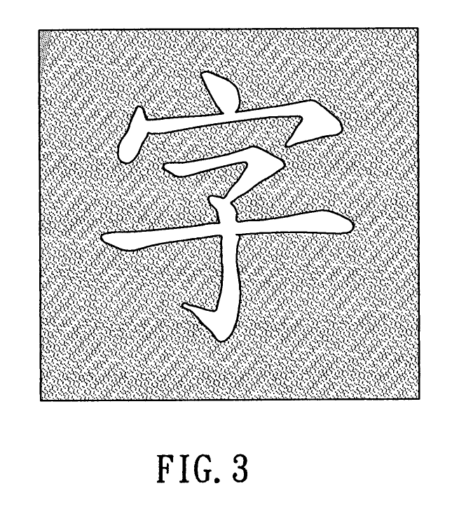

According to the second embodiment of the present invention (see FIG. 3), the lighting fixture of the present invention is made in the form of a light box (or signboard). In this case, the cover shell 4 has a light-permeable area that shows a predetermined letter or pattern, and the other area of the cover shell 4 beyond the light-permeable area is opaque. When the light emitting devices 2 are turned on, the light of the light emitting devices 2 passes through the patterned light-permeable area, showing a pattern of light.

According to the third embodiment of the present invention as shown in FIG. 3, light-permeable glass, acrylic, resin or polycarbonate chips 5 are fixedly fastened to the top side of the cover shell 4 when molding the cover shell 4 on the substrate 1 and the holder base 3 over the light emitting devices 2, and the other area of the outside wall of the cover shell 4 is darkened to block light. When turned on the light emitting devices 2, the light of the light emitting devices 2 passes through the light-permeable chips 5, producing a lighting effect.

According to the fourth embodiment of the present invention as shown in FIG. 5, the cover shell 4 has a coarse surface 6 formed subject to a predetermined pattern. The coarse surface 6 has the advantage of decorative and anti-slip characteristics.

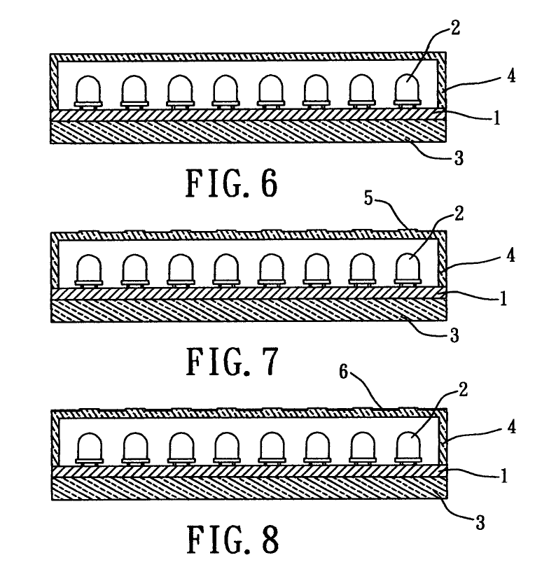

FIGS. 6, 7 and 8 show the fifth, sixth and seventh embodiments of the present invention. The embodiment shown in FIG. 6 is substantially similar to the embodiment shown in FIG. 3 with the exception that the cover shell 4 of this embodiment is a hollow structure The embodiment shown in FIG. 7 is substantially similar to the embodiment shown in FIG. 4 with the exception that the cover shell 4 of this embodiment is a hollow structure. The embodiment shown in FIG. 8 is substantially similar to the embodiment shown in FIG. 5 with the exception that the cover shell 4 of this embodiment is a hollow structure.

Although particular embodiments of the invention have been described in detail for purposes of illustration, various modifications and enhancements may be made without departing from the spirit and scope of the invention.

What the invention claimed is:

1. A lighting fixture comprising:
a holder base;
a substrate fixedly mounted on said holder base;
a plurality of light emitting devices installed in said substrate and electrically connected to together; and
a cover shell package covering said holder base and said substrate and said light emitting devices.

2. The lighting fixture as claimed in claim 1, wherein said substrate is selected from one of board members including printed circuit board, polycarbonate board and acrylic board, having a circuit arranged thereon and electrically connected to said light emitting devices and an electric wire for connection to external electric means.

3. The lighting fixture as claimed in claim 1, wherein said light emitting devices are selected from: light emitting diodes, luminescent lamps, and their combination.

4. The lighting fixture as claimed in claim 1, wherein said cover shell is molded from a resin mixture containing hard grain members selected from sands, glass grains, metal grains and ceramic grains.

5. The lighting fixture as claimed in claim 1, wherein said cover shell is molded from a resin mixture containing a fire retardant.

6. The lighting fixture as claimed in claim 1, wherein said cover shell is molded from a resin that guides lights.

7. The lighting fixture as claimed in claim 6, wherein said cover shell is molded from a resin containing at least one color pigment.

8. The lighting fixture as claimed in claim 1, wherein said cover shell has a light-permeable area that shows a predetermined pattern, and an opaque area surrounding said light-permeable area.

9. The lighting fixture as claimed in claim 1, which has the shape of a tile for construction.

10. The lighting fixture as claimed in claim 1, wherein said cover shell has light-permeable chips fixedly fastened the outer surface thereof and the area of the outer surface beyond said light-permeable chips darkened to block light.
